(19) United States
(12) Patent Application Publication
(10) Pub. No.: US 2006/0200296 A1
(43) Pub. Date: Sep. 7, 2006

(54) Portable hand-held reusable vehicle speed limiting device

(76) Inventor: Dana Stephen Chase, Santa Barbara, CA (US)

Correspondence Address: Dana Stephen Chase;Apartment C, 1500 Chapala Street, Santa Barbara, CA, 93101, US

(21) Appl. No.: 11/073,494

(22) Filed: Mar. 7, 2005

(51) Int. Cl. B60T 8/32

(52) U.S. Cl. 701/93

(57) ABSTRACT

The Portable Hand-held Reusable Vehicle Speed Limiting Device (the Invention) is a hand-held, single person portable device intended to allow the user to set the maximum speed of a freight delivery or passenger vehicle that is propelled by an engine powered by a fuel source by means of installing a usage license to the vehicle's On-Board Engine Management Computer (OBEMC). After the license has been installed to the vehicle's OBEMC by the Invention, the vehicle will not exceed the speed set by the user of the Invention, regardless of who operates the vehicle or what input they give to the vehicle's throttle mechanism.

### CROSS REFERENCE OR RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Operating a vehicle faster than the posted speed limit is against the law on all public roads. However, speeding in a motorized vehicle is a commonplace occurrence. Currently, business owners and the judicial system have no passive control over how fast people travel in their vehicles. A business owner must rely on trust and faith that his/her employees are obeying speed limits when utilizing company vehicles. The judicial system must order large fines and/or jail time to an individual caught breaking the speed laws. Neither trust nor fines nor jail time guarantees that the operator of a vehicle will not break the speed laws. At this time, there are no systems or devices which enable a vehicle to be passively speed controlled and/or allow that speed control to be changed once a vehicle has been manufactured.

It is known that the majority of internal combustion and/or electric/hybrid engine freight transport and passenger vehicles manufactured and/or sold for use in the United States today have some sort of On-Board Engine Management Computer (OBEMC). This computer, which is configured by the manufacturer, is an integral part of engine operation. While these OBEMCs serve many uses, a primary responsibility is to manage the flow of fuel/electricity to the engine and there-by control the fuel/electricity consumption rate for maximum efficiency and to limit the physical speed of the vehicle. Because some vehicle engines are capable of propelling a vehicle faster than what is safe for the operation of the vehicle, passenger and freight vehicle manufacturers purposely limit the physical speed of many vehicles by means of programs which run in the OBEMCs. Once the OBEMC has been properly programmed, the OBEMC interfaces with other subsystems of the vehicle to slow the fuel/electricity delivery to the engine when the vehicle approaches the maximum speed set by the manufacturer. This, in turn, insures that the vehicle can never travel faster than has been deemed safe by the vehicle's design engineers and the manufacturer.

An object of this Invention is to allow a third party to alter the programming code in a vehicle's on-board engine management computer to place a limit on the vehicle's speed. Once the limit has been established, regardless of who operates that vehicle, he/she will not be able to make the vehicle travel faster than the speed limit to which the vehicle was set by means of manipulation of the vehicle's throttle mechanism.

It is of great concern to trucking companies, rental car agencies and business owners that have company cars that their employees and customers operate their vehicles in accordance with the law. Not only can doing so save them money in wear and tear on a vehicle, but may also help prevent many vehicle accidents which may leave the business owners vulnerable to litigation from an injury or death as a result of the vehicle having been breaking the speed limit laws of the area.

It is also theoretically possible that the judicial system may deliver punishments for vehicle related infractions, misdemeanors and/or felonies that include having the guilty party's vehicle forcibly speed controlled by the Invention in order to lessen the likelihood of a repeat vehicle offense, thereby providing reasonable assurance to the community to which the justice system serves that the guilty party cannot repeat offend.

Another object of the Invention is also to allow any person to voluntarily limit the speed of their own vehicle in the interest of potentially saving money on car insurance, to help prevent accidental vehicle speed infractions and to possibly lower their fuel costs as a result of the more efficient use of fuel from operating the vehicle at slower speeds and within the confines of local traffic laws.

### BRIEF SUMMARY OF THE INVENTION

A stated object of the Invention is to allow the user to append, modify or extend the programming of a target vehicle's on-board engine management computer for the purpose of limiting the physical speed of that vehicle. Once set, no operator of that vehicle can cause the vehicle to exceed the speed limitation placed upon the vehicle by the user of the Invention by use of the vehicle's throttle mechanism.

### BRIEF DESCRIPTION OF THE SEVERAL VIEWS OF THE DRAWING

FIG. 1 is a schematic multi-angle view illustration of the inventive device embodying the invention.

### DETAILED DESCRIPTION OF THE INVENTION

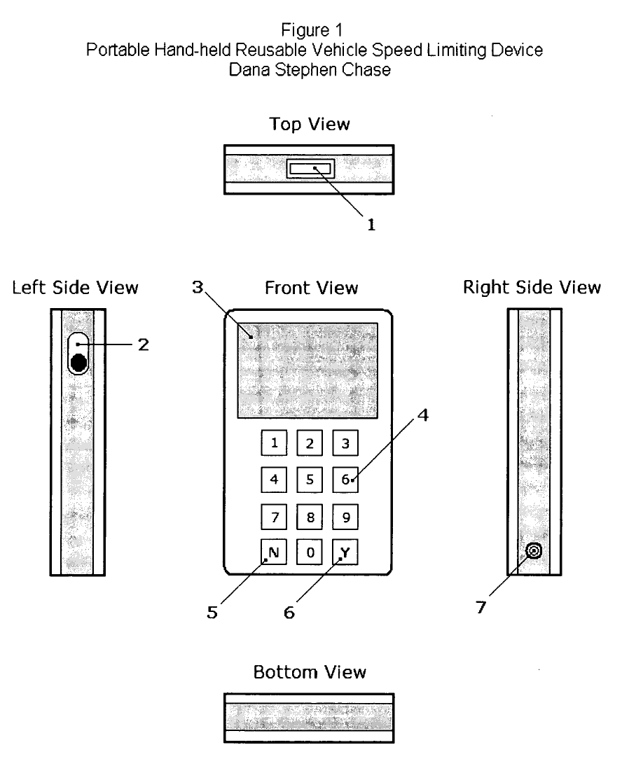

FIG. 1 illustrates in schematic form the general concept of the invention and illustrates the following feature proposed for its use; 1 a the communication port necessary for establishing communication between the Invention, the target vehicle for receiving the usage license and/or a license manager for the purpose of downloading and uploading license information and programming code to and from a database warehouse. 2 a power on/off switch for the device. 3 a monochrome display for illustrating textual information concerning the state of the Invention, stored licenses on board the Invention, license information concerning a target vehicle, license status for a target vehicle and activity in-progress displays for uploading and downloading information to and from a computer connected to the internet. 4 a 10 digit numeric keypad to allow the user to input serial numbers, passwords and speed information to the target vehicle. 5 a “No” selection key to allow the user to cancel an action erroneously selected by the user. 6 a “Yes” select key to allow the user to progress through the license upload/download process in the affirmative. 7 a battery recharge receptacle for the purpose of recharging the batteries of the Invention from an AC power source.

Operation:

The user of the Invention need first mate the Invention with a license manager device via a communication link. Once communication from the device is established, the user would then download one or more licenses from an online data warehouse via the license manager. The license information would then be transferred to the Invention from the license manager.

The Invention would be taken to the target vehicle and a new communication link would be established between the target vehicle and the Invention. The target vehicle's ignition would be turned to the “Run” position so that the vehicle and its engine management computer would be powered by the vehicle's battery system.

Once the vehicle has been turned on, the Invention would be turned on and would automatically interface with the target vehicle establishing a communication link with the vehicle. The target vehicle would send information to the Invention which would both uniquely identify the vehicle to the Invention as well as inform the Invention what language requirements were necessary to modify the programming language contained in the engine management computer.

Once the information had been exchanged and the communication protocols established, the user would be provided with a prompt screen on the Invention with which to interface. The user would then choose whether (s)he wanted to (1) add, (2) remove or (3) check on the status of a current license.
1. If the user wished to add a license and there-by limit the speed of the vehicle,

(s)he would choose that option and be presented with a query from the Invention requesting what speed (s)he desired. The user would then input the desired maximum speed of the vehicle and would then be presented with a query from the Invention as to how long this license should be active on the vehicle. The user of the Invention could choose from between 1 day to 365 days (1 year) in increments of 1 day. The user would also input a 5 digit numeric code of his/her choosing as a password to prevent the license from being removed without authorization. Upon completion of this step, a success or failure message would be passed to the Invention to be displayed to the user. If successful, the license would be installed.
The user could then power off the Invention, disconnect the communication link with the target vehicle, and turn the ignition off on the target vehicle. From that moment forward, for a period of time as specified by the user of the Invention, regardless of who operates the vehicle, the vehicle's on-board engine management computer would limit the speed of the vehicle to the speed set by the user of the Invention.
2. If the user wished to remove a license and there-by remove the speed limitation previously installed onto a target vehicle by the invention, (s)he would connect the device to a license manager. The user would then connect to an online web page and/or database warehouse where the user would indicate that (s)he wanted to remove a license. The user would be prompted to input the serial number of the license as well as the password for that license. Once the serial number and license were verified, a removal license would be granted to the Invention for use on the target vehicle and downloaded from the license manager to the Invention.
The user would then establish communication with the target vehicle in the same manner as described in option “1” above and select the “Remove License” option from the Invention's menu. If the user selected this option, a query would be given to the user to insure that this was the intended action. If the user selected to the affirmative, the license would be removed.

The user could then power off the Invention, disconnect the communication link with the target vehicle, and turn the ignition off on the target vehicle. Once the speed limitation license was removed from the target vehicle, the on-board engine management computer would then default to the manufacturer installed speed limitation.

3. If the user wished to check the status of a current license installed on a target vehicle or verify that one was installed, (s)he would choose this option from the Invention's menu. It would not be necessary to input a serial number or pass code for this operation. The Invention would then query the target vehicle's on-board engine management computer and display the following information to the user:
A. If a license was installed and active on the target vehicle.
B. When the active license was installed.
C. How long the license was specified to be active for when it was installed.
D. How long (in days) the current license would continue to be active for.
E. What speed the license was limiting the target vehicle to.
F. The serial number of the Invention device used to install the license.
G. The serial number of the license installed.
H. The serial number of the Invention device used to remove the previously installed license if no active license was found within the target vehicle.

After completion of any of the above operations, the user of the Invention would re-establish a communication link between the Invention and the license manager. The Invention would then upload the license data to a remotely maintained online database warehouse where those records would be centrally maintained.

The embodiments of the invention in which an exclusive property or privilege is claimed are defined as follows:

1. A device enabling the delivery of a usage license to an engine management computer installed in a freight delivery or passenger vehicle having a variable speed engine powered by a fuel source.

2. The license, according to claim 1, appends, modifies or extends the programming code contained within the engine management computer of the vehicle for the purpose of over-riding the physical speed limitation imposed by the manufacturer of the vehicle if the manufacturer-installed speed limitation is greater than the Invention-installed license.

3. The license, according to claim 1, appends, modifies or extends the programming code contained within the engine management computer of the vehicle for the purpose of installing and enforcing a physical speed limitation of the vehicle if none were previously installed by the manufacturer.

4. The enforcement of the license, according to claims 2 and 3, is accomplished by Invention-delivered programming code which appends, modifies or extends the programming code of the vehicle's on-board engine management computer which, in turn, interfaces with installed systems and subsystems of the engine and vehicle for the purpose of limiting the physical speed of the vehicle, regardless of engine throttle input by the operator of said vehicle.

5. A device that accepts manual input from the user to communicate with the target vehicle and its engine management computer and deliver a usage license to specify what the maximum speed possible is desired for the vehicle by the user on the Invention.

6. A device that allows the removal of a previously installed usage license thereby removing the speed restriction previously placed on the vehicle and returning the programming instructions in the on-board engine management computer of the target vehicle to its original state as defined by the manufacturer of the vehicle.

7. A device that can be used to interface with the target vehicle and its engine management computer for the purposes of determining what, if any, current licenses and speed restrictions are installed in the target vehicle
